(19) United States
(12) Patent Application Publication
(10) Pub. No.: US 2021/0320786 A1
(43) Pub. Date: Oct. 14, 2021

(54) PRINTING DEVICES TO CONTROL ACCESS TO DATA

(71) Applicant: Hewlett-Packard Development Company, L.P., Spring, TX (US)

(72) Inventors: Shell Sterling Simpson, Boise, ID (US); Matthew Russell Tollestrup, San Diego, CA (US)

(73) Assignee: Hewlett-Packard Development Company, L.P., Spring, TX (US)

(21) Appl. No.: 17/267,515

(22) PCT Filed: Nov. 14, 2018
(86) PCT No.: PCT/US2018/060952

§ 371 Date: Feb. 10, 2021

(51) Int. Cl. H04L 9/08

(52) U.S. Cl. CPC H04L 9/088; H04L 9/0861

(57) ABSTRACT

An example printing device includes: printing components; a communication interface to communicate with a server; a memory storing a cryptographic key and a device identifier; and a processor connected to the printing components, the communication interface and the memory, the memory further storing instructions, the processor to execute the instructions. The instructions are to: generate usage data indicative of usage of the printing components. The instructions are further to: encrypt the usage data using the cryptographic key to generate encrypted usage data. The instructions are further to: transmit, using the communication interface, the encrypted usage data to the server for storage with the device identifier. The instructions are further to: receive a request to transmit the cryptographic key to the server to decrypt the encrypted usage data. The instructions are further to: in response, transmit, using the communication interface, the cryptographic key to the server with the device identifier.

### BACKGROUND

Managed services for printing devices may be provided by an entity which may maintain the printing devices of a company and the like once an agreement is reached to do so. However, prior to reaching an agreement, the company that owns or leases the printing devices first engages the entity offering the managed services such that the entity can provide an offer. However, the entity must first gain access to the printing devices (e.g. after being contacted by the company that owns or leases the printing devices) to install software which, during an assessment period, causes the printing devices to transmit usage data to a central server of the entity, so that the managed services to be provided to the printing devices can be assessed. Such managed services may include device maintenance and replacing consumables at the printing devices. Such an approach introduces significant delay in providing the managed services, which can lead to improper maintenance of the printing devices and/or consumables not being replaced in a timely fashion, each which can lead to the printing devices becoming at least partially inoperable.

### BRIEF DESCRIPTION OF THE DRAWINGS

Reference will now be made, by way of example only, to the accompanying drawings in which:

FIG. 1 is a block diagram of an example printing device to control access to data;

FIG. 2 is a block diagram of a system that includes another example printing device to control access to data;

FIG. 3 is a flowchart of an example of a method for controlling access to data at a printing device;

FIG. 4 is a flowchart of an example of a method for controlling access to data at a server;

FIG. 5 is a block diagram of a system implementing a portion of methods to control access to data;

FIG. 6 is a block diagram of the system of FIG. 5 implementing a further portion of methods to control access to data;

FIG. 7 is a block diagram of the system of FIG. 5 implementing a further portion of methods to control access to data;

FIG. 8 is a block diagram of the system of FIG. 5 implementing a further portion of methods to control access to data;

FIG. 8 is a block diagram of the system of FIG. 5 implementing a further portion of methods to control access to data.

### DETAILED DESCRIPTION

Managing a fleet of printing devices may present a challenge. For example, staff at a company may purchase or lease a fleet of printing devices and attempt to manage the printing devices in-house. After a time, however, such management may become unwieldy and/or outside the purview of the staff of the company, who may waste their time to troubleshooting printers and replacing consumables (e.g. printing cartridges, paper, etc.). As such, a managed printing services entity may be engaged to manage the fleet of printing devices; however, before such an entity provide such managed services, the printing services entity may study the fleet of printing devices during an assessment period to determine a level of managed service that may be needed, and a commensurate cost for such managed services. Such an assessment period, which may occur by installing software on the printers after the printing services entity is contacted by the company that owns and/or leases the printing devices, may delay the rollout of the managed services which may lead to the printing devices being improperly serviced by the company that owns/leases the printing devices, and/or further waste the time of IT staff, and the like, maintaining the printing devices.

Hence, provided herein is a printing device which may have preinstalled software to transmit encrypted data indicative of usage of printing components to a server of a printing services entity. The printing device generally encrypts the data indicative of usage of printing components. The encrypted data may be decrypted using a cryptographic key which may be generated by the printing device, for example when first powered on, and which is hence unknown to the server. The cryptographic key may the same key used to encrypt the data, or a complementary key. In some examples, the printing device may transmit the encrypted data indicative of usage of printing components, to the server, when permission to do is so is received at the printing device, for example via input received at an input device. The server receives and stores the encrypted data indicative of usage of printing components, but cannot decrypt the encrypted data until permission is received to obtain the cryptographic key. Indeed, when permission is received, the printing device transmits the cryptographic key to the server. Once the cryptographic key is received, for example when a company that is operating the printing device engages the printing services entity, the server may decrypt the data indicative of usage of printing components and determine usage of the printing components without having to go through an assessment period.

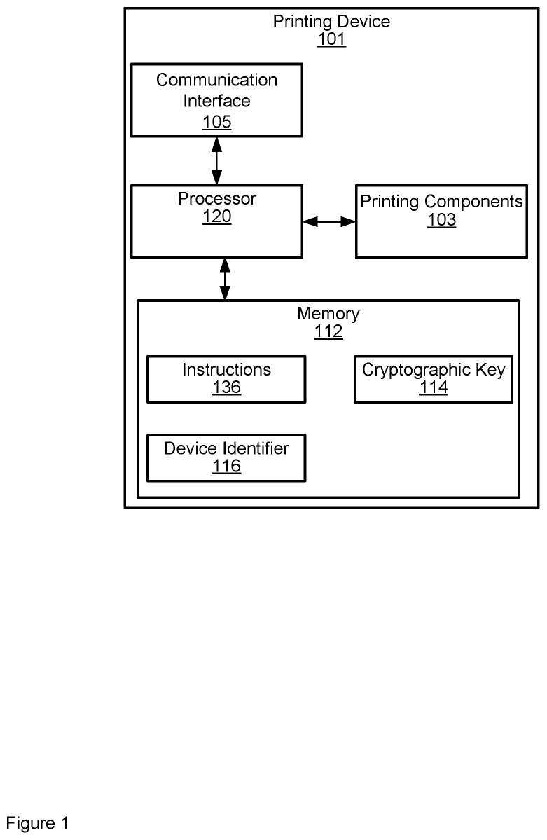

Referring to FIG. 1, a printing device 101 to control access to data is depicted. The printing device 101 comprises: printing components 103; a communication interface 105 to communicate with a server (not depicted); a memory 112 storing a cryptographic key 114 and a device identifier 116; and a processor 120 connected to the printing components 103, the communication interface 105 and the memory 112, the memory 112 further storing instructions 136, the processor 120 to execute the instructions 136. The instructions 136 are to: generate usage data indicative of usage of the printing components 103; encrypt the usage data to generate encrypted usage data; transmit, using the communication interface 105, the encrypted usage data to the server for storage with the device identifier 116; receive a request to transmit the cryptographic key 114 to the server to decrypt the encrypted usage data, the cryptographic key 114 to decrypt the encrypted usage data; and, in response, transmit, using the communication interface 105, the cryptographic key 114 to the server with the device identifier 116.

The printing device 101 may include additional components, such as various additional interfaces and/or input/output devices such as display screens to interact with a user or an administrator of the printing device 101. The printing device 101 may be to generally print printed materials using the printing components 103 which may include, but are not limited to, print heads, printing cartridges, mechanical components such as feed mechanisms (e.g. for paper), and the like.

The communication interface 105 is to communicate with the server, for example via a network, such as a wired or wireless network which may include one or more of the Internet, a cellular network, a WiFi network, and the like.

In addition, the printing device 101 may communicate with an other device and/or server (e.g. different from the server receiving encrypted usage date), via the communication interface 105, or another communication (and/or network) interface, to receive print jobs to print printed materials at the printing device 101 using the printing components 103. Such communication may occur via one or more of the Internet, a cellular network, a WiFi network, a Bluetooth™ network, a Zigbee™ networks, a local area network (LAN), and the like.

The memory 112 is coupled to the processor 120 and includes a non-transitory machine-readable storage medium that may be any electronic, magnetic, optical, or other physical storage device. The non-transitory machine-readable storage medium of the memory 112 may include, for example, random access memory (RAM), electrically-erasable programmable read-only memory (EEPROM), flash memory, a storage drive, an optical disc, and the like. The memory 112 may also be encoded with executable instructions to operate the communication interface 105 and other hardware in communication with the processor 120. In other examples, it is to be appreciated that the memory 112 may be substituted with a cloud-based storage system. Indeed the non-transitory machine-readable storage medium of the memory 112 is generally encoded with the instructions 136 executable by the processor 120 of the printing device 101.

The non-transitory machine-readable storage medium of the memory 112 may include, for example, random access memory (RAM), electrically-erasable programmable read-only memory (EEPROM), flash memory, a storage drive, an optical disc, and the like. The memory 112 may also be encoded with executable instructions to operate the communication interface 105 and other hardware in communication with the processor 120. In other examples, it is to be appreciated that the memory 112 may be substituted with a cloud-based storage system.

The memory 112 may also store an operating system that is executable by the processor 120 to provide general functionality to the printing device 101, for example, functionality to support various applications such as a user interface to access various features of the printing device 101. Examples of operating systems include Windows™, macOS™, iOS™, Android™, Linux™, and Unix™. The memory 112 may additionally store applications that are executable by the processor 120 to provide specific functionality to the printing device 101, and which may include the instructions 136.

The processor 120 may include a central processing unit (CPU), a microcontroller, a microprocessor, a processing core, a field-programmable gate array (FPGA), an application-specific integrated circuit (ASIC) or similar. The processor 120 and memory 112 may cooperate to execute various instructions such as the instructions 136.

Accordingly, the processor 120 may execute instructions stored on the memory 112 to implement print jobs to print the printed materials using the printing components 103; such instructions may be in addition to the instructions 136 and/or a component of the instructions 136. Regardless, the processor 120 monitors the printing components 103 to determine data indicative of usage of the printing components 103. Such data indicative of usage of the printing components 103 may include, but is not limited to, one or more of: a frequency that a printing cartridge is replaced; a rate of use of ink, and the like, at a printing cartridge; frequency and/or rate of print jobs; numbers of print jobs as a function of time; a frequency of jamming and/or breakage of mechanical components, such as feed mechanisms, and the like.

Indeed, the data indicative of usage of the printing components 103 may be generally used to determine a maintenance schedule of the printing device 101, which may include, but is not limited to, a schedule to replace printing cartridges (e.g. before ink runs out), a schedule to replace paper, a schedule to replace mechanical components, a schedule to clean and/or service a print head, a recommendation for a different printing device (e.g. as the printing device 101 may not meet the needs of a company and/or entity using the printing device 101), and the like.

Such the usage data may include, but is not limited to, print job level usage data (e.g. a type of a print job, a number of pages of the print job) and which may also include a timestamp of each print job.

Hence, the processor 120 and/or the instructions 136 may be further to: monitor the usage of the printing components 103 by monitoring usage of consumables (e.g. paper, printing cartridges) by the printing components 103 or a number of times the printing components 103 are used as a function of time.

The cryptographic key 114 may include any suitable cryptographic key including, but not limited to, a symmetric key, and the like. In these examples, processor 120 and/or the instructions 136 may be further to: encrypt the usage data, indicative of usage of the printing components 103, using the cryptographic key 114. Hence, in these examples, the cryptographic key 114 may be to both encrypt and decrypt the usage data.

In some of these examples, the processor 120 and/or the instructions 136 may be further to: generate the cryptographic key 114 when the printing device 101 is first powered on; and store the cryptographic key 114 in the memory 112. For example, the instructions 136 may be further to generate the cryptographic key 114 from a MAC (media access control) address, and the printing device 101 and/or the device identifier 116 and/or using a time and/or date, and the like.

Indeed, the device identifier 116 may comprise one or more of: a MAC address of the printing device 101, a serial number of the printing device 101, an internet protocol (IP) address of the printing device 101, the like.

However, in some examples, the cryptographic key 114 may be asymmetric and include a public key of a private/public key pair, (e.g. as issued by a certificate authority, and the like). In these examples, the memory 112 may store the private key, complementary to the public key, and the processor 120 and/or the instructions 136 may be to further to encrypt the usage data using the private key. In some of these examples, the processor 120 and/or the instructions 136 may be further to communicate with a certificate authority to obtain the digital certificate signed by the private key, the digital certificate including the public key. In these examples, the private key (and optionally the public key, which may be obtained by the printing device 101 after shipping) may be stored in the memory 112 in a factory setting, for example, in a secure manner such that the manufacturer of the printing device 201 does not have access to the private key.

Regardless, the processor 120 generally encrypts the data indicative of usage of the printing components 103 and transmits the encrypted data to the server for storage, and the cryptographic key 114 is for decrypting the encrypted data.

In some of these examples, for example, where the cryptographic key 114 is symmetric, the processor 120 and/or the instructions 136 may also be to: generate the cryptographic key 114 and a control code when the printing device 101 is first powered on; store the cryptographic key 114 in the memory 112 in association with the control code; and receive the control code with the request to transmit the cryptographic key 114 to the server, the cryptographic key 114 and the device identifier 116 being transmitted when the control code received with the request matches the control code stored in the memory 112.

For example, the control code may comprise random alphanumeric text and/or a random number, and the like, generated by the processor 120. The control code may be provided to the server as authorization and/or permission for the server to decrypt the previously received encrypted data indicative of usage of the printing components 103, for example to generate an assessment of the usage data, and the like, for servicing the printing device 101.

However, in other examples, the memory 112 may further store a control code in association with the cryptographic key 114 regardless of whether the cryptographic key 114 is symmetric or asymmetric. For example the control code may be received at an input device of the printing device 101, for example when the printing device 101 is first powered on and stored in association with the cryptographic key 114. For example, a user of the printing device 101 may be prompted to enter a control code via the input device. Alternatively, the control code may be generated by the processor 120 and stored in association with the cryptographic key 114; in these examples, the control code may be generated by the processor 120 and rendered at a display screen of the printing device 101 such that a user of the printing device 101 may record the control code for later usage in an authorization procedure.

In yet further examples, the printing device 101 may further comprise an input device, and the memory 112 may further store a control code in association with the cryptographic key 114. In some of these examples, the processor 120 and/or the instructions 136 may be are further to: receive the request to transmit the cryptographic key 114 by receiving the control code via the input device, for example, in an authorization procedure to transmit the cryptographic key 114 to the server, such that the server may decrypt the previously received encrypted data indicative of usage of the printing components 103.

However, the user of the printing device 101 may contact a user of the server and provide the user of the server with the control code for input at the server. In these examples, the processor 120 and/or the instructions 136 may also be to: receive the request to transmit the cryptographic key 114 to the server by receiving the control code via the communication interface 105.

Hence, the processor 120 and/or the instructions 136 may be further to: receive a control code associated with the cryptographic key 114, the control code received via the communication interface 105 or an input device of the printing device 101.

However, in yet further examples, an employee, and the like, of the entity operating the server to which the encrypted usage data is transmitted by visit the company operating the printing device 101 and collect the device identifier 116 and optionally the control code. Indeed, when the company is operating a plurality of printing devices, the employee may collect respective device identifiers (and, optionally, associated control codes) from each of the plurality of printing devices. For example, each of the plurality of printing devices may be operated to print a respective device identifier and control code. The employee may then enter the respective device identifiers (and control codes) at the server which transmits a request for a respective cryptographic key to each of the plurality of printing devices.

In some examples, prior to the encrypted data being generated and transmitted, permission to do so is received at the printing device 101. For example, the processor 120 and/or the instructions 136 may be further to, when printing device 101 is first powered on: provide, at a display screen of the printing device 101, rendered data indicative of requesting permission to transmit the encrypted usage data to the server; and receive, via an input device, input indicative of permission to transmit the encrypted usage data to the server, the encrypted usage data being generated and transmitted after receiving the input indicative of permission.

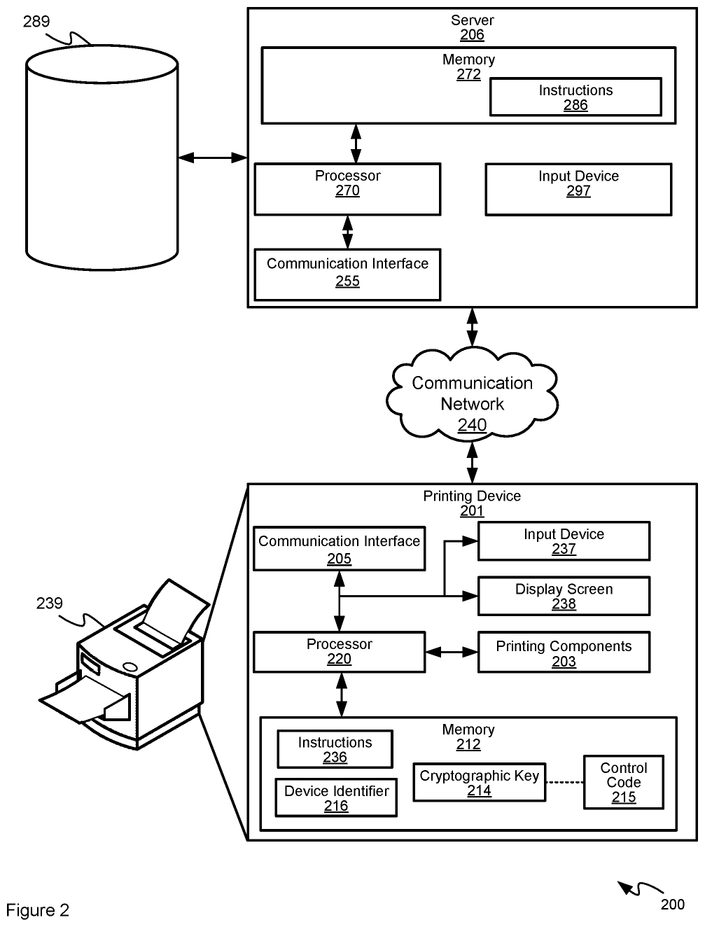

FIG. 2 depicts a schematic block diagram of a system 200 that includes a printing device 201 similar to the printing device 101, with like components having like numbers, but in a “200” series rather than a “100” series. Hence, the printing device 201 comprises: printing components 203; a communication interface 205 to communicate with a server 206; a memory 212 storing a cryptographic key 214 (e.g. in association with a control code 215) and a device identifier 216; and a processor 220 connected to the printing components 203, the communication interface 205 and the memory 212, the memory 212 further storing instructions 236, the processor 220 to execute the instructions 236. The instructions 236 are to: generate usage data indicative of usage of the printing components 203; encrypt the usage data to generate encrypted usage data; transmit, using the communication interface 205, the encrypted usage data to the server 206 for storage with the device identifier 216; receive a request to transmit the cryptographic key 214 to the server 206 to decrypt the encrypted usage data, the cryptographic key 214 to decrypt the encrypted usage data; and, in response, transmit, using the communication interface 205, the cryptographic key 214 to the server 206 with the device identifier 216.

The control code 215 may be used to provide authorization for the server 206 to receive the cryptographic key 214, as described in further detail below. The association between the cryptographic key 214 and the control code 215 at the memory 212 is depicted in FIG. 2 via a dashed line therebetween. The cryptographic key 214 and the control code 215 may be stored and/or generated in any suitable manner, for example as described above with respect to the printing device 101.

As depicted, the printing device 201 further comprises an input device 237 and a display screen 238 which may be used as a human/machine interface to the printing device 201. The input device 237 may include a touchscreen, alphanumeric keypad, and the like, and the display screen 238 may include any suitable flat panel display screen and/or the touchscreen of the input device 237. Indeed, when the display screen 238 comprises the touchscreen of the input device 237, the display screen 238 and the input device 237 may be combined. The input device 237 and the display screen 238 may hence be used by a user of the printing device 201 to enter and/or view the control code 215, as described above, and/or to print the device identifier 216 and the control code 215.

A chassis 239 of the printing device 201 is also depicted in FIG. 2. In particular, the chassis 239 has a configuration of a printer in which paper is fed from an upper tray through a feed mechanism and out onto a lower tray. However, the depicted configuration of the chassis 239 is merely an example, and the chassis 239 and/or the printing device 201 may have any suitable printer configuration.

The system 200 further comprises the server 206 in communication with the printing device 201 via a communication network 240 (interchangeably referred to hereafter as the network 240). Furthermore, communication links between the various components of the system 200 are depicted as double-ended arrows, and which may be wired or wireless as desired.

While only one printing device 201 is depicted in FIG. 2, the system 200 may comprise a plurality of printing devices (including the printing device 201) in communication with the server 206, including, but not limited to a fleet of printing devices purchased and/or leased by a company to provide printing functionality to employees, and the like. However, the plurality of printing devices 201 may include printing devices of a plurality of companies and/or entities, for example different companies, and the like.

The server 206 may comprise a server device, a computing device, a cloud computing device, and the like, associated with an entity offering managed printing services, for example, to the entity operating the printing device 101. Furthermore, the server 206 may be embodied in a plurality of computing devices, for example in a cloud computing environment.

The server 206 generally comprises: a communication interface 255 to communicate with a printing device 201; and a processor 270 connected to the communication interface 255 and a memory 272, the processor 270 to execute instructions 286 stored in the memory 272, the instructions 286 to: receive, via the communication interface 255, from the printing device 201, encrypted usage data of the printing device 201, the encrypted usage data comprising an encrypted version of usage data indicative of usage of the printing components 203 of the printing device 201; store the encrypted usage data in a storage device 289 in association with a device identifier 216 of the printing device 201; transmit, via the communication interface 255, to the printing device 201, a request for the cryptographic key 214 for decrypting the encrypted usage data; receive, via the communication interface 255, from the printing device 201, the cryptographic key 214; decrypt the encrypted usage data using the cryptographic key 214 to generate the usage data; generate an assessment of the usage data; and delete the cryptographic key 214 and the usage data.

The communication interface 255, the processor 270, the memory 272 and the input device 297 may be respectively similar to the communication interface 205, the processor 220, the memory 222 and the input device 237, but adapted for the functionality of the server 206. The server 206 may include other components, not depicted, such as a display screen and the like. Furthermore, the input device 237 may be external to the server 206, and may be a component of a terminal to access the server 206.

As depicted, the storage device 289 comprises a cloud storage device and/or database accessible to the server 206. As depicted, the server 206 is in local communication with the storage device 289, for example via cables, a local area network, and the like. However in other examples the server 206 may be in communication with the storage device 289 via the network 240. In yet further examples, the server 206 may comprise the storage device 289 (e.g. the memory 272 may comprise the storage device 289).

The server 206 is generally to store encrypted data received from the printing device 201 at the storage device 289, in association with the device identifier 216. However, prior to access being granted to the encrypted data, the server 206 does not have access to the unencrypted data. When such access is granted, for example, by receiving the device identifier 216 and/or the control code 215, the server 206 is to request and/or received the cryptographic key 214 from the printing device 201 to decrypt encrypted data received from the printing device 201.

For example, the processor 270 and/or the instructions 286 may be further to: receive the control code 215 associated with the cryptographic key 214; and transmit the request for the cryptographic key 214, the request including the control code 215.

For example, as depicted, the processor 270 is further in communication with the input device 297 (e.g. a keyboard, and the like, which may be external to the server 206). In these examples, the processor 270 and/or the instructions 286 may be further to: receive, using the input device 297, the control code 215 associated with the cryptographic key 214; and transmit the request for the cryptographic key 214, the request including the control code 215. For example, a user of the printing device 201 may communicate the control code 215 to a user of the server 206 to authorize the user of the server 206 to input the control code 215 into the server 206 using the input device 297 to, in turn, authorize the server 206 to access the encrypted data as stored at the storage device 289. Alternatively, a user of the server 206 may visit the printing device 201 and collect the control code 215 (and/or the device identifier 216) therefrom, as described below.

In some examples, processor 270 and/or the instructions 286 may be further to: generate the assessment of the usage data based on indications of usage of consumables at the printing device 201, as stored in the usage data, or a number of times the printing components 203 are used as a function of time, as stored in the usage data. Hence, the assessment of the usage data may include a proposal for providing printer services for the printing device 201 that takes such factors into account.

In some examples, processor 270 and/or the instructions 286 may be further to: receive, via the communication interface 255, from the printing device 201, after deleting the cryptographic key 214 and the usage data, further encrypted usage data in association with the device identifier 216, the further encrypted usage data comprising a further encrypted version of further usage data indicative of further usage of the printing components 203 of the printing device 201. Hence, the server 206 may continue to receive encrypted usage data, which may be combined with the encrypted usage data already received, for example for use in later assessments of usage of the printing device 201.

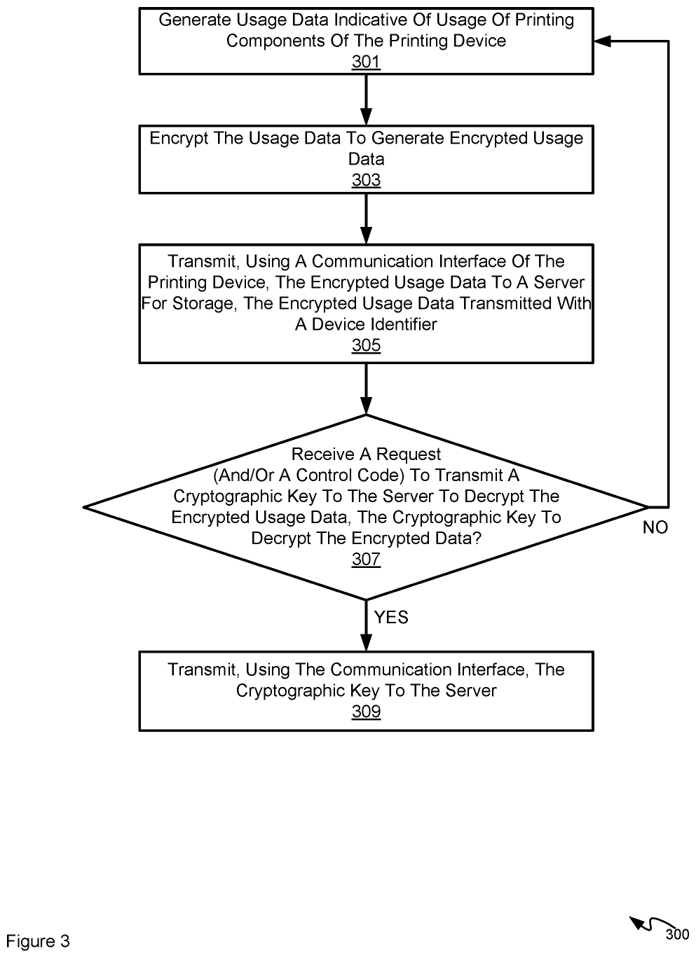

Referring to FIG. 3, a flowchart of a method 300 for controlling access to data is depicted. In order to assist in the explanation of method 300, it will be assumed that method 300 may be performed with the printing device 201, and specifically by the processor 220 implementing the instructions 236. Indeed, the method 300 may be one way in which printing device 201 may be configured to interact with the server 206. Furthermore, the following discussion of method 300 may lead to a further understanding of the processor 220, the printing device 201, the server 206, the system 200, and their various components. Furthermore, the method 300 may be performed with the printing device 101, and for example by the processor 120 implementing the instructions 136. Furthermore, it is to be emphasized, that method 300 may not be performed in the exact sequence as shown, and various blocks may be performed in parallel rather than in sequence, or in a different sequence altogether.

Beginning at a block 301, the processor 220 generates usage data indicative of usage of the printing components 203, as described above.

At a block 303, the processor 220 encrypts the usage data to generate encrypted usage data, as described above.

At a block 305, the processor 220 transmits, using the communication interface 205, the encrypted usage data to the server 206 for storage with the device identifier 216.

In some examples, the processor 220 transmits the encrypted usage data to the server 206 periodically, for example once per day, once per week, and the like, accumulating such encrypted usage data in between transmissions. In other examples, the processor 220 transmits the encrypted usage data to the server 206 as the usage data is generated.

In some examples, the processor 220 transmits the encrypted usage data to the server 206 with the device identifier 216 with each transmission. However, in other examples, the processor 220 registers the printing device 201 with the server 206, including the device identifier 216 and an internet protocol address, and the like, of the printing device 201 (e.g. when the device identifier 216 is different from the internet protocol address); hence, when the server 206 later receives the encrypted usage data from the registered internet protocol address (e.g. without the device identifier 216) the server 206 may store the encrypted usage data at the storage device 289 in association with the previously registered device identifier 216.

At a block 307, the processor 220 determines whether a request to transmit the cryptographic key 214 to the server 206 has been received, the request to decrypt the encrypted usage data, the cryptographic key 214 to decrypt the encrypted usage data. As depicted, the request may include receiving a control code which may be compared with the control code 215 stored in the memory 222.

When a request is not received, or the control code received with a request does not match the control code 215 stored in the memory 222 (e.g. a “NO” decision at the block 307) the processor 220 continues to generate, encrypt and transmit usage data to the server 206 at the blocks 301, 303, 305.

However, when a request is received, and/or the control code received with a request matches the control code 215 stored in the memory 222 (e.g. a “YES” decision at the block 307) in response, at a block 309, the processor 220 transmits, using the communication interface 205, the cryptographic key 214 to the server 206 with the device identifier 216.

Hence, the server 206 may decrypt the previously received encrypted usage data to generate an assessment of the usage data, without introducing an assessment period that begins with installing software at the printing device 201 to transmit the usage data. Furthermore, such a method 300 preserves the privacy of the usage data as the server 206, while receiving and storing the encrypted usage data, does not have access to the unencrypted usage data until permission is received to do so.

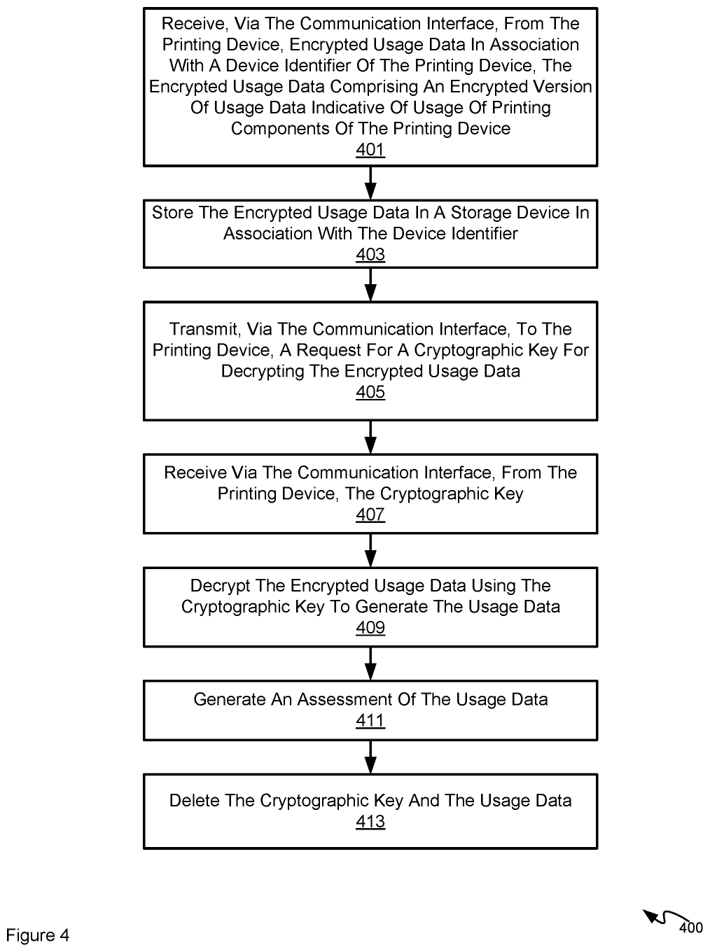

Indeed, referring to FIG. 4, a flowchart of a method 400 for controlling access to data at the server 206 is depicted. In order to assist in the explanation of method 400, it will be assumed that method 400 may be performed with the server 206, and specifically by the processor 270 implementing the instructions 286. Indeed, the method 400 may be one way in which the server 206 may be configured to interact with the printing device 201. Furthermore, the following discussion of method 400 may lead to a further understanding of the processor 270, the server 206, the printing device 201, the system 200, and their various components. Furthermore, it is to be emphasized, that method 400 may not be performed in the exact sequence as shown, and various blocks may be performed in parallel rather than in sequence, or in a different sequence altogether.

Beginning at a block 401, the processor 270 receives, via the communication interface 255, from the printing device 201, encrypted usage data of the printing device 201, the encrypted usage data comprising an encrypted version of usage data indicative of usage of the printing components 203 of the printing device 201, as described above.

At a block 403, the processor 270 stores the encrypted usage data in a storage device 289 in association with the device identifier 216.

At a block 405, the processor 270 transmits, via the communication interface 255, to the printing device 201, a request for the cryptographic key 214 for decrypting the encrypted usage data. The request may include the device identifier 216 received from the printing device 201 and/or via the input device 297. The request may further include the control code 215 received from the printing device 201 and/or via the input device 297.

At a block 407, the processor 270 receives, via the communication interface 255, from the printing device 201, the cryptographic key 214. The cryptographic key 214 is generally received in response to transmitting the request of the block 405.

At a block 409, the processor 270 decrypts the encrypted usage data using the cryptographic key 214 to generate the usage data. Hence, the processor 270 now has access to the usage data as generated at the printing device 201.

At a block 411, the processor 270 generates an assessment of the usage data, as described elsewhere in the present specification.

At a block 413, the processor 270 deletes the cryptographic key 214 and the usage data.

Hence, the server 206 receives the encrypted usage data, for example before being engaged by the company operating the printing device 201 but does not have access to the unencrypted usage data until permission is received to do so, for example when the cryptographic key 214 is received. The server 206 may then decrypt the encrypted usage data to generate the assessment without introducing an assessment period that begins with installing software at the printing device 201 to transmit the usage data. Furthermore, once the server 206 has decrypted the encrypted usage data to generate the assessment, the usage data (e.g. as decrypted) and the cryptographic key 214 are deleted, for example to continue to preserve the privacy of the usage data. The method 400 may continue to be implemented after the usage data and the cryptographic key 214 are deleted, for example to again generate an assessment of usage data at a later time based on the encrypted usage data previously received and stored in the storage device 289, and further encrypted usage data received as the method 400 continues to be implemented. In some examples, however, historic encrypted usage data stored in the storage device 289 may be deleted after a given period of time, for example to store the encrypted usage date only for a given period of time (e.g. a year and/or a time period configurable by an administrator of the server 206).

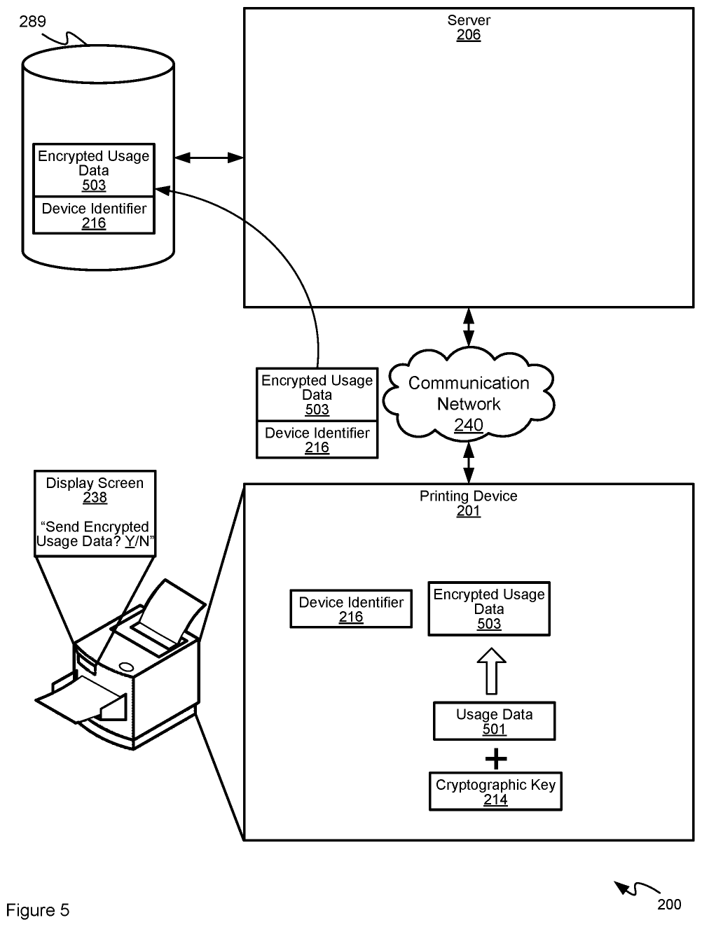

Attention is next directed to FIG. 5 to FIG. 9 which depicts an example of the method 300 and the method 400. For example, FIG. 5 to FIG. 9 each depicts the system 200, however not all components of the printing device 201 and the server 206 are shown. Such components are, however, present (e.g. the processors 220, 270, etc. are present at the printing device 201 and the server 206). Furthermore, in FIG. 5 to FIG. 9, the processor 220 of the printing device 201 is implementing the instructions 236, and the processor 270 is implementing the instructions 286.

Attention is first directed to FIG. 5 which depicts an interaction with the display screen 238, for example when the printing device 201 is first powered on. In particular, the processor 220 may control the display screen 238 to provide a selectable option as to whether encrypted usage data is to be transmitted to the server 206. As depicted, a user of the printing device 201 has interacted with display screen 238 (e.g. via a touch screen) to select “Y” that, yes, the encrypted usage data is to be transmitted to the server 206.

As such, the printing device 201 is depicted as generating (e.g. at the block 301 of the method 300) usage data 501 of the printing components 203, encrypting (e.g. at the block 303 of the method 300) the usage data 501 using the cryptographic key 214 to generate encrypted usage data 503, and transmitting (e.g. at the block 305 of the method 300) the encrypted usage data 503 to the server 206. As depicted, the encrypted usage data 503 is transmitted with the device identifier 216.

As also depicted in FIG. 5, the server 206 is receiving (e.g. at the block 401 of the method 400) the encrypted usage data 503, and storing e.g. at the block 403 of the method 400) at the storage device 289, for example in association with the device identifier 216.

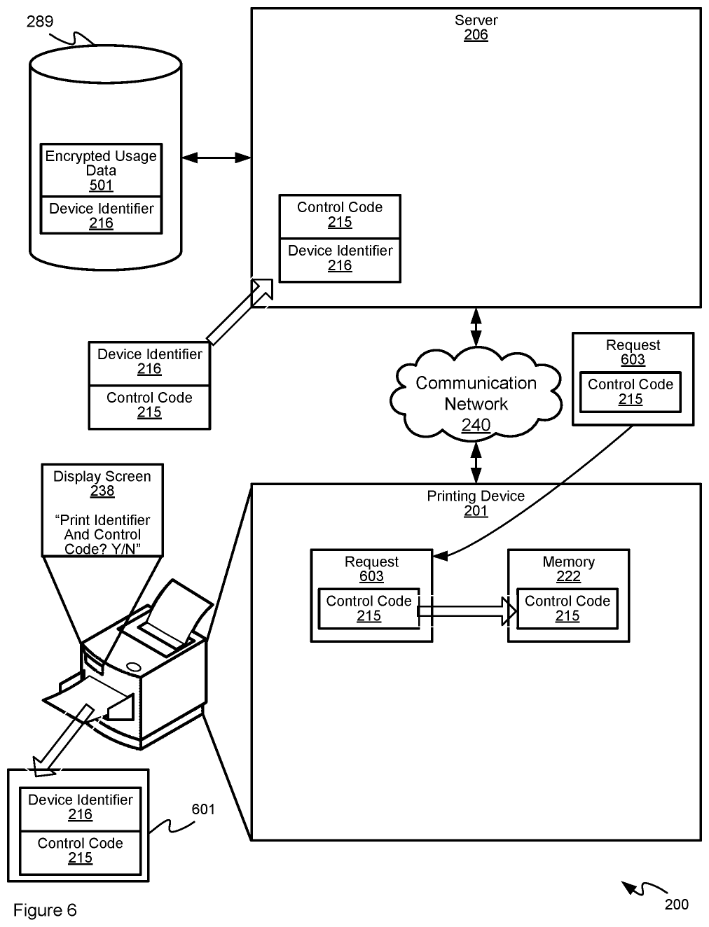

Attention is next directed to FIG. 6 which depicts another interaction with the display screen 238 for example after a period of time during which the printing device 201 has been transmitting the encrypted usage data 503 to the server 206. In this example, via a user of the printing device 201 interacting with a menu system provided at the display screen 238, the processor 220 may control the display screen 238 to provide a selectable option to request printing of the device identifier 216 and optionally the control code 215. As depicted, a user of the printing device 201 has interacted with display screen 238 (e.g. via a touch screen) to select “Y” that, yes, printing of the device identifier 216 and optionally the control code 215 is to occur. In some examples (not depicted), the processor 220 may request entry of the control code 215 (and/or a password) for further authorization.

As such, as also depicted in FIG. 6, the printing device 201 prints a page 601 that includes the device identifier 216 and optionally the control code 215. As depicted, the device identifier 216 and optionally the control code 215 are entered and/or received at the server 206, for example using data entry techniques using the input device 297. Alternatively, the device identifier 216 and optionally the control code 215 may be transmitted as a message to the server 206 (e.g. via an email, and the like transmitted from a communication device of a user of the printing device 201, and the like). Alternatively, the printing device 201 may be controlled to transmit an authorization of assessment of the usage data 501 to the server 206 that includes the device identifier 216 and optionally the control code 215

Regardless, the server 206 receives the device identifier 216 and optionally the control code 215. As depicted, in response, the server 206 is transmitting (e.g. at the block 405 of the method 400) a request 603 for the cryptographic key 214 the printing device 201, the request 603 including the control code 215. As also depicted in FIG. 6, the printing device 201 is receiving the request 603 (e.g. at the block 307 of the method 300) and determines that the control code 215 in the request 603 matches the control code 215 as stored in the memory 222.

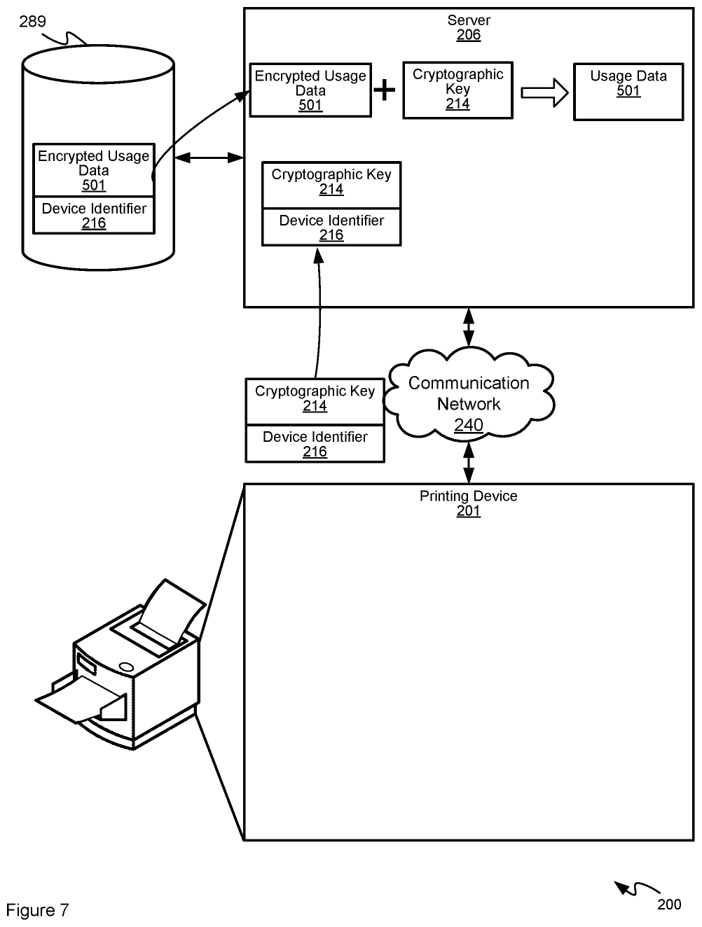

As such, in FIG. 7, the printing device 201 is depicted as transmitting (e.g. at the block 309 of the method 300) the cryptographic key 214 to the server 206, for example in association with the device identifier 216. The server 206 is receiving (e.g. at the block 407 of the method 400) the cryptographic key 214. The server 206 may use the device identifier 216 to retrieve the encrypted usage data 503 from the storage device 289. The server 206 is further depicted as decrypting (e.g. at the block 409 of the method 400) the encrypted usage data 503, using the cryptographic key 214, to generate the usage data 501.

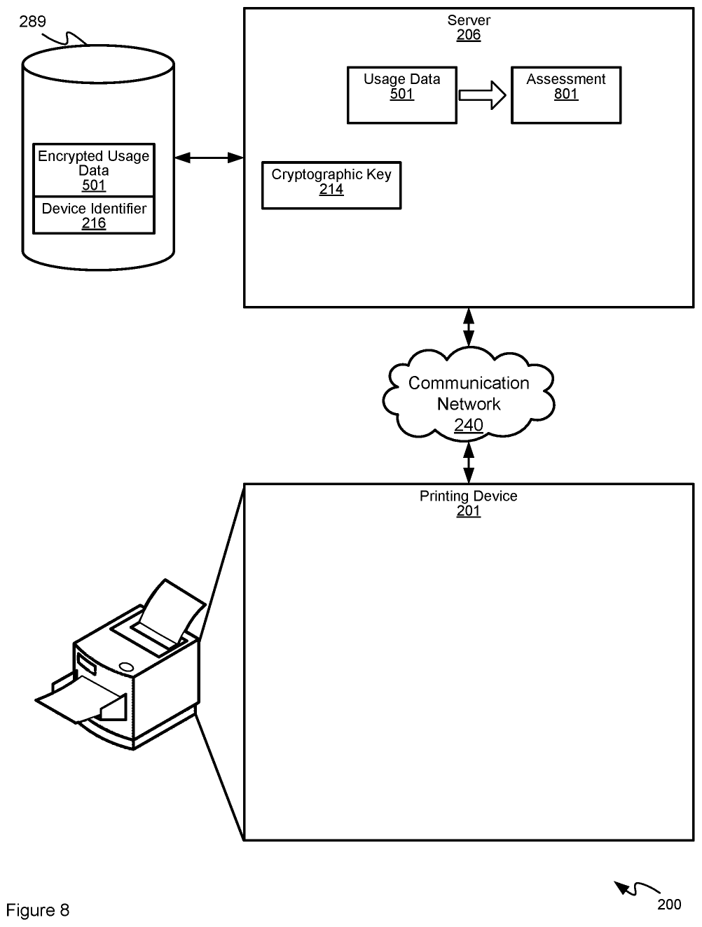

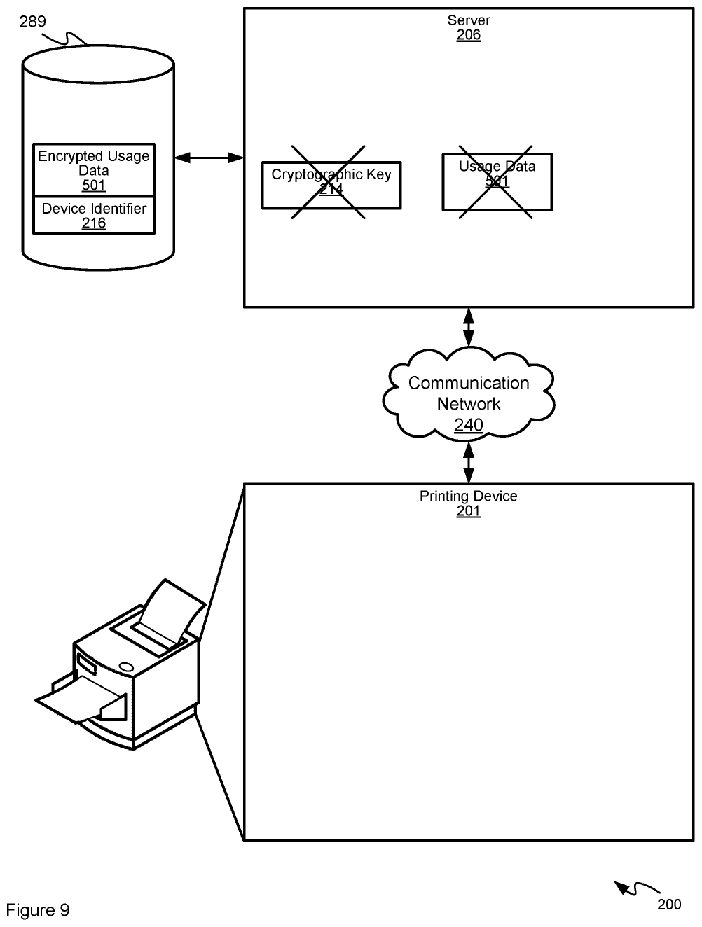

Attention is directed to FIG. 8 which depicts the server 206 generating (e.g. the block 411 of the method 400) an assessment 801 of the usage data 501, which may include, but is not limited to, a schedule for servicing the printing device 201, as well as associated costs.

FIG. 9 further depicts the server 206 deleting (e.g. the block 413 of the method 400) the cryptographic key 214 and the usage data 501 to preserve the privacy of the encrypted usage data 501 stored at the storage device 289.

In general, the assessment 801 may be transmitted to a communication device associated with a user and/or administrator of the printing device 201 to determine whether the entity associated with the server 206 is to be engaged for printing manage services. Deletion of the cryptographic key 214 and the usage data 501 may ensure ongoing privacy of the usage data of the printing device 201.

While present examples are described with respect to the server 206 collecting encrypted usage data for one printing device, present examples include the server 206 collecting encrypted usage data for a plurality of printing devices, such that the method 300 may be implemented at the plurality of printing devices, and the server 206 may implement the method 400 to generate an assessment of usage data for the plurality of printing devices, based on encrypted usage data and respective cryptographic keys received from each of the plurality of printing devices. In this manner, the assessment generated at the block 411 of the method 400 may include a proposal for providing printer services for all of the plurality of printing devices.

It should be recognized that features and aspects of the various examples provided above may be combined into further examples that also fall within the scope of the present disclosure.

1. A printing device comprising:
printing components;
a communication interface to communicate with a server;
a memory storing a cryptographic key and a device identifier; and
a processor connected to the printing components, the communication interface and the memory, the memory further storing instructions, the processor to execute the instructions, the instructions to:
generate usage data indicative of usage of the printing components;
encrypt the usage data using the cryptographic key to generate encrypted usage data;
transmit, using the communication interface, the encrypted usage data to the server for storage with the device identifier;
receive a request to transmit the cryptographic key to the server to decrypt the encrypted usage data; and, in response,
transmit, using the communication interface, the cryptographic key to the server with the device identifier.

2. The printing device of claim 1, wherein the instructions are further to
generate the cryptographic key when the printing device is first powered on; and
store the cryptographic key in the memory.

3. The printing device of claim 1, wherein the instructions are further to
generate the cryptographic key and a control code when the printing device is first powered on;
store the cryptographic key in the memory in association with the control code; and
receive the control code with the request to transmit the cryptographic key to the server, the cryptographic key and the device identifier being transmitted when the control code received with the request matches the control code stored in the memory.

4. The printing device of claim 1, wherein the memory further stores a control code in association with the cryptographic key, and the instructions are further to: receive the request to transmit the cryptographic key to the server by receiving the control code via the communication interface.

5. The printing device of claim 1, The printing device of claim 1, further comprising an input device, wherein the memory further stores a control code in association with the cryptographic key, and the instructions are further to:
receive the request to transmit the cryptographic key by receiving the control code via the input device.

6. A non-transitory machine-readable storage medium encoded with instructions executable by a processor of a printing device, the non-transitory machine-readable storage medium comprising:
instructions to: generate usage data indicative of usage of printing components of the printing device;
instructions to: encrypt the usage data using a cryptographic key, stored in a memory of the printing device, to generate encrypted usage data;
instructions to: transmit, using a communication interface of the printing device, the encrypted usage data to a server for storage, the encrypted usage data transmitted with a device identifier;
instructions to: receive a control code associated with the cryptographic key, the control code received via the communication interface or an input device of the printing device; and, in response,
instructions to: transmit, using the communication interface, the cryptographic key to the server.

7. The non-transitory machine-readable storage medium of claim 6, further comprising instructions to:
generate the cryptographic key and the control code when the printing device is first powered on; and
store the cryptographic key in the memory in association with the control code.

8. The non-transitory machine-readable storage medium of claim 6, further comprising instructions to, when printing device is first powered on:
provide, at a display screen of the printing device, rendered data indicative of requesting permission to transmit the encrypted usage data to the server; and
receive, via the input device, input indicative of permission to transmit the encrypted usage data to the server, the encrypted usage data being generated and transmitted after receiving the input indicative of permission.

9. The non-transitory machine-readable storage medium of claim 6, further comprising instructions to: monitor the usage of the printing components by monitoring usage of consumables by the printing components or a number of times the printing components are used as a function of time.

10. The non-transitory machine-readable storage medium of claim 6, further comprising instructions to: transmit, using the communication interface, the encrypted usage data to the server for storage with the device identifier and a timestamp.

11. A server comprising:
a communication interface to communicate with a printing device; and
a processor connected to the communication interface and a memory, the processor to execute instructions stored in the memory, the instructions to:
receive, via the communication interface, from the printing device, encrypted usage data in association with a device identifier of the printing device, the encrypted usage data comprising an encrypted version of usage data indicative of usage of printing components of the printing device;
store the encrypted usage data in a storage device in association with the device identifier;
transmit, via the communication interface, to the printing device, a request for a cryptographic key for decrypting the encrypted usage data;
receive, via the communication interface, from the printing device, the cryptographic key;
decrypt the encrypted usage data using the cryptographic key to generate the usage data;
generate an assessment of the usage data; and
delete the cryptographic key and the usage data.

12. The server of claim 11, wherein the instructions are further to:
receive a control code associated with the cryptographic key; and
transmit the request for the cryptographic key, the request including the control code.

13. The server of claim 11, wherein the processor is further in communication with an input device, wherein the instructions are further to:
receive, using the input device, a control code associated with the cryptographic key; and
transmit the request for the cryptographic key, the request including the control code.

14. The server of claim 11, wherein the instructions are further to:
generate the assessment of the usage data based on indications of usage of consumables at the printing device, as stored in the usage data, or a number of times the printing components are used as a function of time, as stored in the usage data.

15. The server of claim 11, wherein the instructions are further to:
receive, via the communication interface, from the printing device, after deleting the cryptographic key and the usage data, further encrypted usage data in association with the device identifier, the further encrypted usage data comprising a further encrypted version of further usage data indicative of further usage of the printing components of the printing device.
